(19) United States
(12) Patent Application Publication
(10) Pub. No.: US 2007/0214707 A1
(43) Pub. Date: Sep. 20, 2007

(54) Combination fishing garment and fishing rod holder

(76) Inventor: David R. Walko, Punxsutawney, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/804,565

(22) Filed: May 18, 2007

Related U.S. Application Data
(63) Continuation-in-part of application No. 11/216,943, filed on Aug. 31, 2005, now abandoned.

(51) Int. Cl. A01K 97/10

(52) U.S. Cl. 43/21.2

(57) ABSTRACT

A combination fishing vest and fishing rod holder. The fishing rod holder includes two spaced pole rests which consist of J-hooks respectively, one vertically inverted from the other, which are respectively secured to opposite sides of a front portion of a fishing vest or a similar garment for transversely supporting a fishing rod therebetween across the vest in cantilevered fashion at a chest high position.

### CROSS REFERENCE

This application is a continuation-in-part of U.S. patent application Ser. No. 11/216,943, filed Aug. 31, 2005, and entitled A COMBINATION FISHING GARMENT AND FISHING ROD HOLDER AND METHOD OF MANUFACTURE.

### BACKGROUND OF THE INVENTION

This invention relates to a fishing rod carrier or holder, and more particularly to a fishing rod holder which frees up the fisherman's hands for preparatory operations, such as tying on new flies, retrieving fish from the net or washing one's hands without permitting the fishing reel to engage or otherwise dip into the water.

Various types of rod carriers or holders have been devised for temporarily supporting a fishing rod and reel combination, particularly for use in fly fishing. However, some carriers are relatively inaccessible as they mount the rod to the back of the fisherman and other such carrier systems either place the rod in a position where it interferes with the use of the fisherman's hands when trying to accomplish other tasks, or the carrier holds the rod and reel in such a position that the fishing reel is easily and undesirably immersed into the water while the fisherman is accomplishing preparatory tasks.

It is a principal object of the present invention to provide a fishing rod holder which is devoid of these aforementioned shortcomings.

### SUMMARY OF THE INVENTION

The present invention provides a combination fishing garment and fishing rod holder wherein the combination includes an upper torso garment, such as a fishing vest, a fishing rod holder, including two spaced pole rests in the form of J-hooks, one inverted from the other, respectively secured to opposite sides of a front portion of the garment for transversely supporting a fishing rod therebetween across the garment at chest high in a cantilevered fashion. This rod holder provides temporary support for the rod and reel combination, and because of the positioning at chest high, it permits full unrestricted use of the fisherman's arms and hands for other preparatory tasks. Also, the rod is further so positioned whereby the reel cannot and will not engage the water in which the fisherman is standing, even if the fisherman leans over to wash his or her hands or to handle a fish in the fishing waters.

The pole rests generally each include a J-hook, one inverted from the other, to support the rod therein. The J-hooks may be identical in shape and are positioned with one being vertically inverted from the other. For example, for a right handed fisherman, the J-hook positioned on the right hand side of the fisherman's garment would be secured to the garment in a vertical upright position with the cradle portion of the J-hook facing upward to receive the fishing rod just forward of the reel. In this configuration, the other J-hook would be vertically inverted from the first J-hook and positioned on the left side of the fisherman's garment with the cradle of this J-hook facing downwardly whereby more forward portions of the fisherman's rod would protrude through this second J-hook and rest upwardly against the cradle portion of the second J-hook in cantilevered fashion. If desired, the second inverted J-hook may also be provided with a spring clip closure to ensure that the rod tip and/or the line therein is retained within the J-hook.

The J-hooks are preferably sold as a pair separately from the garment to which they are attached and provided with means for securing them to ones fishing vest or any other desired garment at the spaced chest high position.

### BRIEF DESCRIPTION OF THE DRAWINGS

Other objects and advantages appear hereinafter in the following description and claims. The accompanying drawings show, for the purpose of exemplification, without limiting the scope of the invention or appended claims, certain practical embodiments of the present invention wherein:

FIG. 1 is a view in front elevation of the fishing garment and fishing rod holder of the present invention;

FIGS. 2A and 2B are enlarged views of the J-hooks used for the fishing rod holder shown in combination with means for securing the J-hooks to a fishing vest;

FIGS. 3A and 3B are back side views of the J-hook with the spring biased keeper shown in FIG. 2B respectively in its closed and open positions;

FIG. 4A is an enlarged life size front view of the first J-hook of the present invention shown in a vertical upright position illustrating another embodiment of the present invention;

FIG. 4B is a view in side elevation of the J-hook illustrated in FIG. 4A shown together with securement screws for securing the J-hook to a garment;

FIG. 4C is a back view of the J-hook illustrated in FIGS. 4A and 4B;

FIG. 5A is an enlarged back view of the second inverted J-hook of the present invention;

FIG. 5B is a side view of the J-hook shown in FIG. 5A, together with the screws used for securing the same to a garment; and

FIG. 5C is a front view of the inverted J-hook of FIGS. 5A and 5B.

### DETAILED DESCRIPTION OF A PREFERRED EMBODIMENT

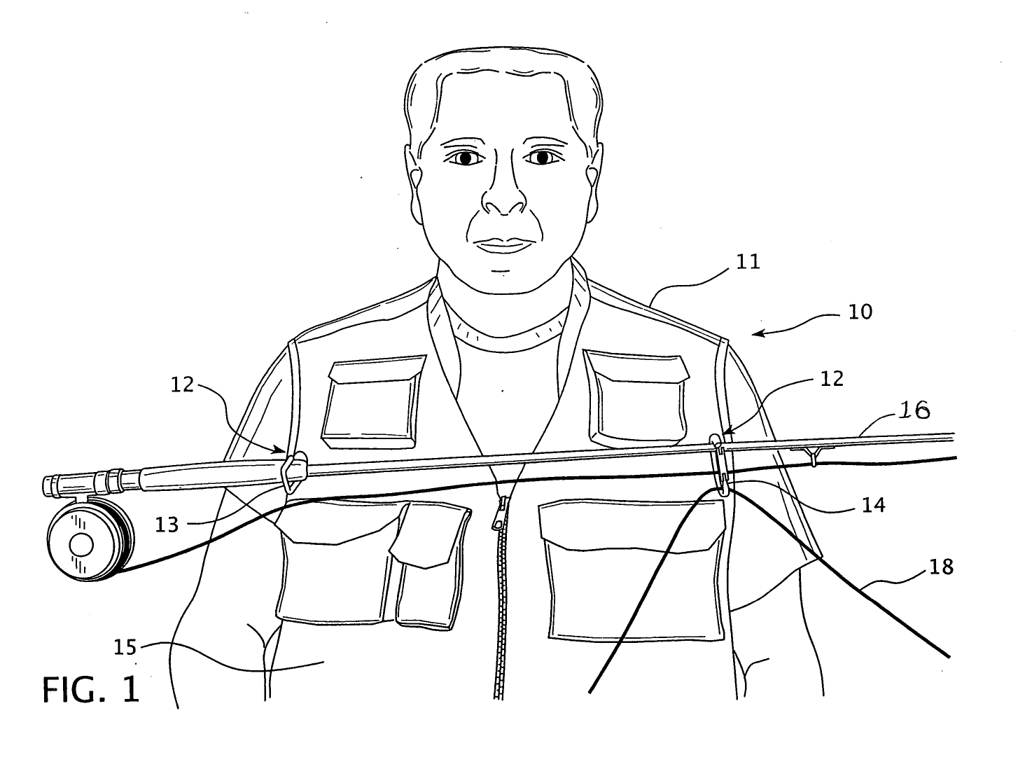

Referring to the embodiment of FIGS. 1 through 3, the combination fishing garment and fishing rod holder 10 is illustrated as a combination of upper torso garment 11 in the form of a fishing vest with a zipper front and fishing rod holder 12 provided by two spaced pole rests 13 and 14 secured to opposite sides of front portion 15 of garment 11 for transversely supporting fishing rod 16 therebetween across garment 11 at chest high as illustrated, thereby leaving the wearer's arms free to perform various preparatory tasks.

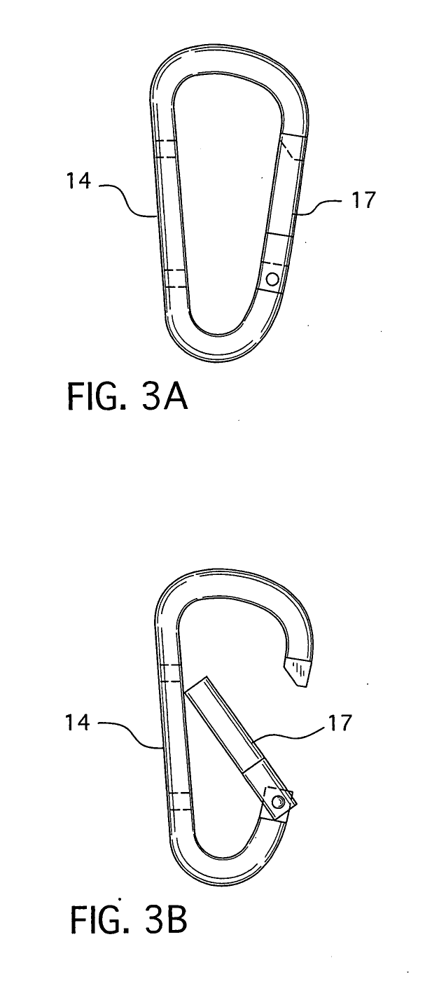

The two pole rests 12 are in the form of J-hooks. J-hook 13 is open and vertically upright, and J-hook 14 is inverted so that the fishing pole is supported in cantilevered fashion between the rests 12 with the pole pushing up against the saddle of inverted J-hook 14. J-hook 14 is provided with a spring biased keeper 17 closing the gap between the distal ends of the opposing J-hook ends thereby closing the gap as is best illustrated in FIG. 3. This permits retention of the pole 16 and fishing line 18 therein as illustrated in FIG. 1 and prevents accidental dislodgement.

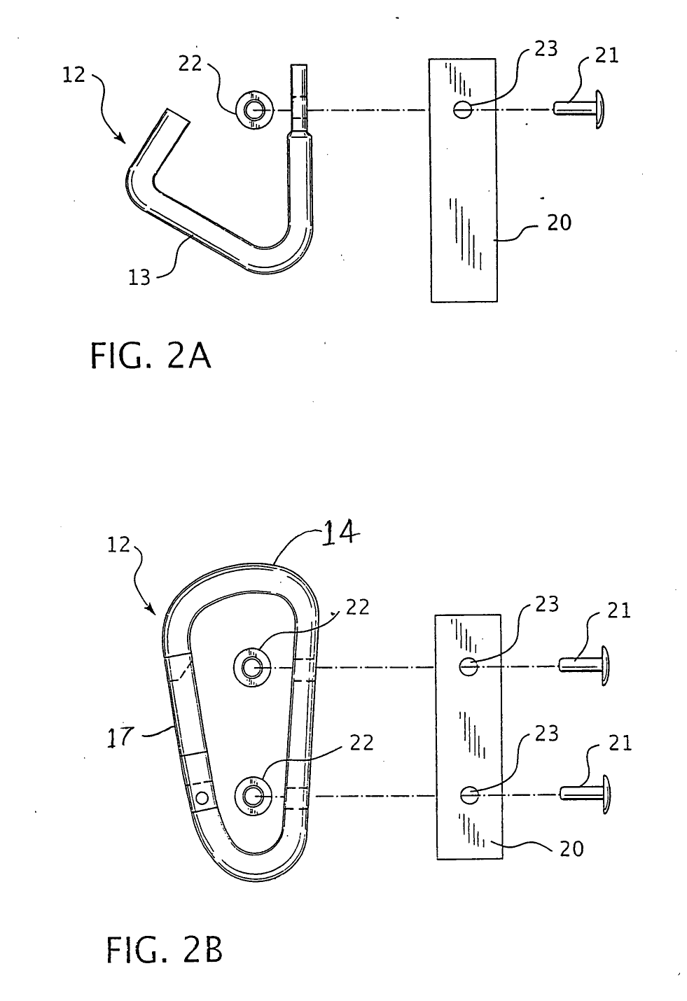

As is illustrated in FIGS. 2A and B, the J-hooks 13 and 14 may be provided separately with backup plates 20 provided with rivet openings 23, rivets 21 and rivet caps 22 to provide independent securement of the J-hooks 13 and 14 to the fishing vest of the purchaser.

The combination fishing garment and fishing rod holder 10 of the present invention is illustrated as a combination of upper torso garment 11 in the form of a fishing vest with a zipper front and a fishing rod holder 12 provided by two spaced pole rests in the form of upright J-hook 13 and inverted J-hook 14 secured to opposite sides of the front portion of garment 11 at chest high as illustrated, thereby leaving the wearer's arms free to perform various preparatory tasks.

Pole rest 12 is in the form of a vertically upright J-hook 13 and supports the fishing rod just forward of the fishing reel in the cradle portion of J-hook 13. Inverted J-hook 14 is inverted so that the fishing pole as illustrated in FIG. 1 is supported in cantilevered fashion between the rests 12 with the pole pushing up against the cradle of inverted J-hook 14. Inverted J-hook 14 in this embodiment is also provided with a spring biased keeper 17 closing the gap of the J-hook as best illustrated in FIG. 3. This permits retention of the pole 16 and fishing line 18 therein as illustrated in FIG. 1 and prevents accidental dislodgement. However the use of the keeper 17 is not required as is illustrated hereinafter in a second embodiment.

As illustrated in FIGS. 2A and B, the J-hooks 13 and 14 are provided with backup plates 20 that are also provided with rivet openings 23 and rivets 21, and rivet caps 22 provide independent securement of the J-hooks 13 and 14 to the fishing vest or garment.

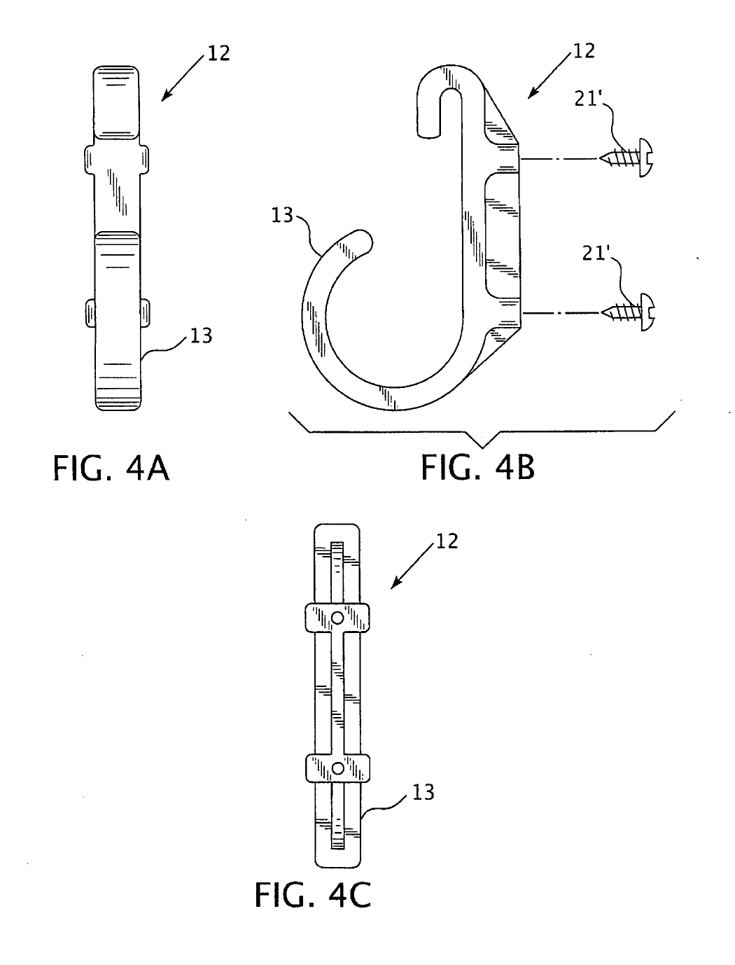

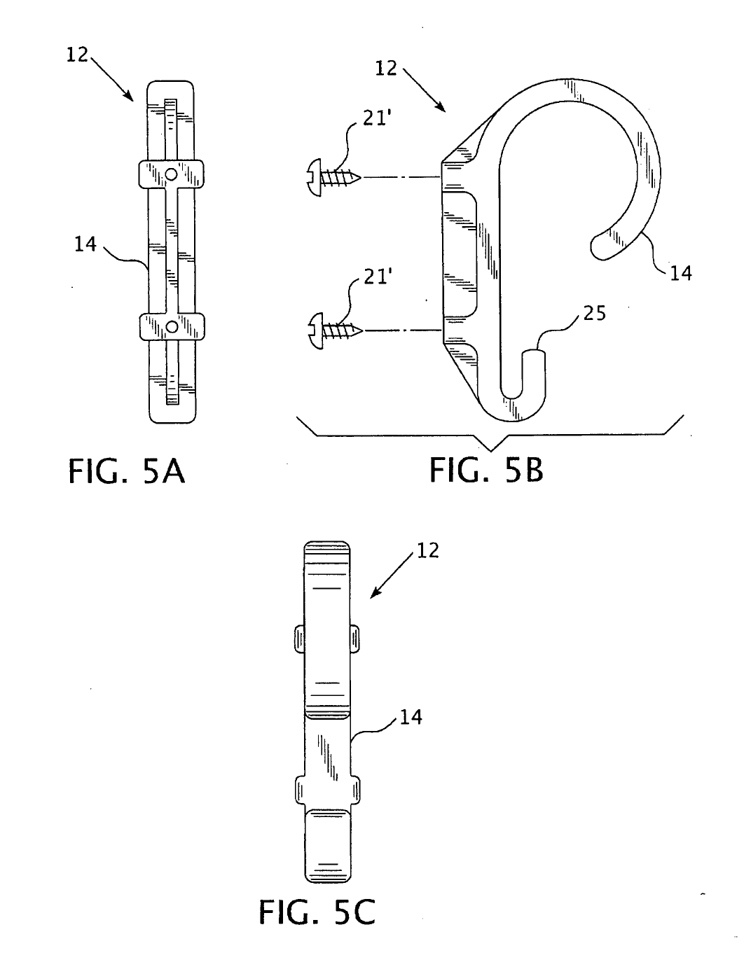

Referring next to FIGS. 4 and 5, another embodiment of the J-hooks used in the combination of the present invention are illustrated. Like elements are indicated with the same reference numerals. In this embodiment the first upright J-hooks 13 are illustrated in FIGS. 4A through 4C, and the second J-hooks are illustrated in FIGS. 5A through 5C. J-hooks 13 and 14 are identical in configuration in this embodiment and are molded of a suitable plastic and they are secured to the fishing garment with stainless steel self tapping screws 21′ in stead of the rivets 21 utilized in the first embodiment. In addition to the J-hooks 13 and 14 being identical in construction, J-hook 13 is attached to the fishing garment, as before, in a vertically upright condition as illustrated, and J-hook 14 is attached to the garment, in spaced relationship from J-hook 13 at chest high, in a vertically inverted position as illustrated.

In this embodiment no keeper elements, such as keeper 17 for J-hook 14 in the previous embodiment, are required or utilized. The bottom hook 25 in FIG. 5B is used to loop loose fishing line thereover similar to the line 18 as shown in FIG. 1 which is looped over a bottom hook portion on J-hook 14.

I claim:

1. A combination fishing garment and fishing rod holder comprising:
an upper torso garment;
a fishing rod holder including two spaced pole rests respectively secured to opposite sides of a front portion of said garment at chest high for transversely supporting a fishing rod therebetween across said garment at chest high;
said pole rests comprised respectively of vertically positioned J-hooks with one of said J-hooks being inverted from the other for thereby supporting a fishing rod therebetween in cantilevered fashion.

2. The combination of claim 1, wherein said J-hooks are of identical construction.

3. The combination of claim 2, wherein said J-hooks are plastic and are secured to said garment with self-tapping screws.

4. The combination of claim 1, wherein said inverted J-hook includes a spring biased keeper for closing the hook whereby a pole and fishing line may be releaseably confined therein.

5. The combination of claim 1, wherein said garment is a fishing vest.
